(19) United States
(12) Patent Application Publication
(10) Pub. No.: US 2007/0297767 A1
(43) Pub. Date: Dec. 27, 2007

(54) IMAGE REPRODUCING APPARATUS AND REPRODUCING PROGRAM CREATION APPARATUS

(75) Inventor: Hirofumi Takei, Yokohama-shi, (JP)

Correspondence Address: CANON U.S.A. INC. INTELLECTUAL PROPERTY DIVISION, 15975 ALTON PARKWAY, IRVINE, CA, 92618-3731, US

(73) Assignee: CANON KABUSHIKI KAISHA, Tokyo (JP)

(21) Appl. No.: 11/750,280

(22) Filed: May 17, 2007

(30) Foreign Application Priority Data
May 25, 2006 (JP) 2006-145622

(51) Int. Cl. H04N 7/00

(52) U.S. Cl. 386/96

(57) ABSTRACT

An image reproducing apparatus includes a selection unit configured to select one of a plurality of pieces of image data recorded on a recording medium, a recording unit configured to perform post-recording of audio data upon the piece of image data selected by the selection unit, a measurement unit configured to measure a recording time period of the audio data post-recorded by the recording unit, and a control unit configured to create or update a reproducing program for specifying display periods of a plurality of pieces of image data to be reproduced and a display sequence thereof based on the audio data recording time period measured by the measurement unit.

### BACKGROUND OF THE INVENTION

1. Field of the Invention

The present invention relates to an image reproducing apparatus capable of performing post-recording of audio data such as sound or music data upon recorded image data and reproducing the image data and the audio data in accordance with a reproducing program, and to a reproducing program creation apparatus for creating such a reproducing program.

2. Description of the Related Art

Functions of recording and reproducing apparatuses such as video camcorders include a function of sequentially reproducing a plurality of pieces of recorded still image data (so-called slide show reproduction function). This function is a function of controlling the reproduction of a slide show in accordance with a reproducing program stored in a CPU included in a video camcorder.

Apparatuses that reproduce moving image data, still image data, or audio data on the basis of a user-created list (hereinafter referred to as a playlist) used to specify scenes to be reproduced are known. Furthermore, there are apparatuses capable of setting a reproduction order and a single-image display period.

On the other hand, some video camcorders have a function of allowing audio data to be added to image data that has already been recorded (a so-called post-recording function). Japanese Patent Laid-Open No. 2000-152166 discloses a technique of finishing display of an image so as to display a next image after a recording time of post-recorded audio data has passed in a case where the audio data recording time is longer than a slide show single-image display period.

Since the functions or specifications of reproducing programs stored in built-in CPUs in known video camcorders generally vary from one product type to another, desired reproduction of slide shows recorded using one type of video camcorder sometimes cannot be achieved in another type of video camcorder. In addition, in the case of known video camcorders, since reproducing programs are stored in built-in CPUs included therein, these reproducing programs cannot be transferred or copied between video camcorders. If the method disclosed in Japanese Patent Laid-Open No. 2000-152166 is used, single-image display periods can be matched with recording times of audio data. However, these single-image display periods are individually stored, and are not stored or managed in the form of a reproducing program.

As a known playlist description format, Auto Play File in DPOF (Digital Print Order Format) Version 1.10 is known in the field of digital cameras, and SMIL (Synchronized Multimedia Integration Language), XML (extensible Markup Language), SGML (Standard Generalized Markup Language), HTML (Hyper Text Markup Language), and QuickTime® are known in the field of personal computers. However, in order to manually create a playlist, users have to monitor recorded images and recorded pieces of audio data and control single-image display periods of the images to be reproduced and reproducing times of these pieces of audio data in accordance with the monitoring result in any description format. This method is troublesome for users.

### SUMMARY OF THE INVENTION

The present invention provides a reproducing program creation apparatus for automatically creating or updating a reproducing program when post-recording of audio data is preformed upon recorded image data.

Furthermore, the present invention provides an image reproducing apparatus for effectively using a created reproducing program.

According to an aspect of the present invention, there is provided an image reproducing apparatus configured to reproduce a plurality of pieces of image data in accordance with a reproducing program for specifying display periods of the plurality of pieces of image data to be reproduced and a display sequence thereof. The image reproducing apparatus includes a selection unit configured to select one of a plurality of pieces of image data recorded on a recording medium, a recording unit configured to perform post-recording of audio data upon the piece of image data selected by the selection unit, a measurement unit configured to measure a recording time period of the audio data post-recorded by the recording unit, and a control unit configured to create or update the reproducing program based on the audio data recording time period measured by the measurement unit.

According to another aspect of the present invention, there is provided a reproducing program creation apparatus configured to create a reproducing program for specifying display periods of a plurality of pieces of image data to be reproduced and a display sequence thereof. The reproducing program creation apparatus includes a selection unit configured to select one of a plurality of pieces of image data recorded on a recording medium, a recording unit configured to perform post-recording of audio data upon the piece of image data selected by the selection unit, a measurement unit configured to measure a recording time period of the audio data post-recorded by the recording unit, and a program creation unit configured to create a new reproducing program based on the audio data recording time period measured by the measurement unit.

According to another aspect of the present invention, there is provided a reproducing program creation apparatus configured to create a reproducing program for specifying display periods of a plurality of pieces of image data to be reproduced and a display sequence thereof. The reproducing program creation apparatus includes a selection unit configured to select one of a plurality of pieces of image data recorded on a recording medium, a recording unit configured to perform post-recording of audio data upon the piece of image data selected by the selection unit, a measurement unit configured to measure a recording time period of the audio data post-recorded by the recording unit, and a program updating unit configured to update an existing reproducing program based on the audio data recording time period measured by the measurement unit.

Further features of the present invention will become apparent from the following description of exemplary embodiments with reference to the attached drawings.

### BRIEF DESCRIPTION OF THE DRAWINGS

FIG. 1 is a block diagram illustrating an exemplary configuration of a video camcorder according to an aspect of an exemplary embodiment of the present invention.

FIG. 2A is a perspective view illustrating an external appearance of a video camcorder according to an aspect of an exemplary embodiment of the present invention.

FIG. 2B is an enlarged view of a part of the video camcorder according to an aspect of an exemplary embodiment of the present invention.

FIG. 3 is a diagram illustrating an exemplary directory configuration in a memory card.

FIG. 4 is a flowchart illustrating a procedure for creating a reproducing program according to an aspect of an exemplary embodiment of the present invention.

FIG. 5 is a diagram illustrating exemplary images displayed in rows and columns.

FIG. 6 is a diagram illustrating an exemplary directory configuration in a memory card after post-recording has been performed.

FIG. 7 is a diagram illustrating an exemplary description of a slide show playlist.

FIG. 8 is a flowchart illustrating an operational flow at the time of addition of an image.

FIG. 9 is a diagram illustrating an exemplary description of a slide show playlist after the addition of an image has been performed.

### DESCRIPTION OF THE EMBODIMENTS

Numerous exemplary embodiments, features and aspects of the present invention will be described with reference to the accompanying drawings.

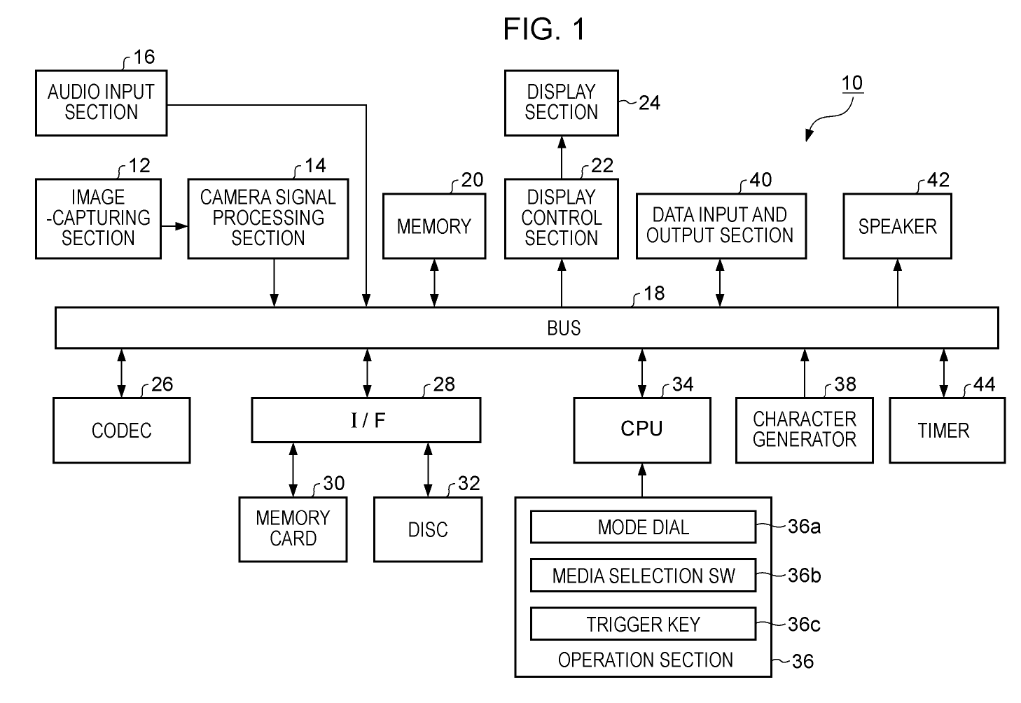

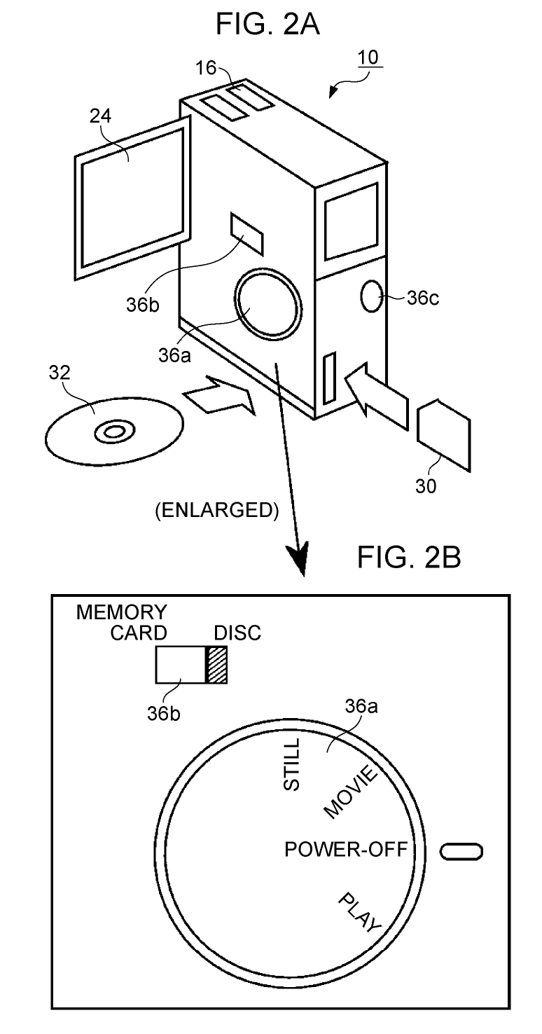

The configuration of a video camcorder according to an aspect of an exemplary embodiment of the present invention will be described with reference to FIGS. 1, 2A, and 2B. FIG. 1 is a block diagram illustrating an exemplary configuration of a video camcorder according to an aspect of an exemplary embodiment of the present invention. FIG. 2A is a perspective view illustrating an external appearance of the video camcorder. FIG. 2B is an enlarged view of a part of the video camcorder. A video camcorder according to the present embodiment serves as a recording and reproducing apparatus for recording and reproducing image data and audio data, an editing apparatus for editing image data and audio data, and a reproducing program creation apparatus.

A video camcorder 10 illustrated in FIG. 1 is a digital video camcorder or a digital camera. The video camcorder 10 includes an image-capturing section 12, a camera signal processing section 14, an audio input section 16, a bus 18, a memory 20, a display control section 22, a display section 24, a codec 26, an interface (I/F) 28 for a removable memory card 30 and a removable disc medium 32 such as a DVD (Digital Versatile Disc), a CPU (Central Processing Unit) 34, an operation section 36, a character generator 38, a data input and output section 40, a speaker 42, and a timer 44.

The operation section 36 is provided with standard operation keys as well as a mode dial 36a, a media selection switch 36b, and a trigger key 36c.

The image-capturing section 12 includes an image pickup device such as a CCD (Charge Coupled Device) or CMOS (Complementary Metal Oxide Semiconductor), an auto focus unit, a zoom unit, and an A/D converter. The image-capturing section 12 converts an optical image of a subject into an electric signal and outputs digital image data.

The camera signal processing section 14 performs various signal processing operations (i.e., gamma correction, color balance control, luminance and color separation) upon the digital image signal transmitted from the image-capturing section 12.

The audio input section 16 is provided with a microphone, an acousto-electric converter, an amplifier circuit, and an A/D converter. The audio input section 16 captures speech of surrounding people and sound and outputs digital audio data.

The bus 18 is used along with a DMA (Direct Memory Access) controller (not shown) to transfer image data, audio data, and control data between the above-described sections.

The memory 20 includes a ROM (Read-Only Memory) for storing a program to be used by the CPU 34 and a parameter registered in advance and a RAM (Random Access Memory) that stores temporary data and functions as a work memory for the CPU 34.

The display control section 22 receives the digital image data from the camera signal processing section 14 via the bus 18 or reproduction image data from the codec 26 via the bus 18 and supplies the received image data to the display section 24, whereby an image that is being captured or recorded or an reproduction image can be displayed on a screen of the display section 24. The display section 24 includes an LCD (Liquid Crystal Display), and may be provided with an EVF (Electric ViewFinder) in addition to the LCD.

The codec 26 is a section functioning as a coder and a decoder. The codec 26 performs compression coding upon the digital image data output from the camera signal processing section 14 and digital audio data output from the audio input section 16 using an image compression method compliant with MPEG (Moving Picture Experts Group phase) 2, H.264 (AVC), JPEG (Joint Photographic Experts Group), Motion JPEG, or JPEG 2000 so as to generate compressed image data and compressed audio data. In addition, the codec 26 can also decode compressed image data and compressed audio data which are reproduced from the memory card 30 or the disc 32.

The I/F 28 electrically connects the memory card 30 and the disc 32 to the bus 18, and reads and writes data from and onto the memory card 30 and the disc 32. The memory card 30 is, for example, a removable flash memory. The disc 32 is, for example, a removable optical disc. That is, the memory card 30 and the disc 32 can record the compressed image data and the compressed audio data which are output from the codec 26. Various optical disc media or magnetic disk media may be used as the disc 32 instead of a DVD.

In the present embodiment, still image data, audio data, and moving image data are compliant with the JPEG format, the WAVE format, and the AVI (Audio Video Interleaving) format respectively, and are recorded on the memory card 30 or the disc 32.

The CPU 34 controls each section included in the video camcorder 10 in accordance with an instruction input from the operation section 36 and the condition of the section.

As previously described, the operation section 36 includes the mode dial 36a, the media selection switch 36b, and the trigger key 36c. In addition, the operation section 36 is provided with a moving image capturing switch, a recording switch, a play switch, and a stop switch as standard operation keys. A user operates these switches, thereby providing the CPU 34 with instructions for selecting a mode, changing a recording medium used, capturing a still image, capturing a moving image, reproducing an image, performing a stop operation, and receiving and recording image data and audio data from an external apparatus.

Furthermore, the operation section 36 is provided with a menu key, an arrow key, an enter key, a slide show button, and a post-recording switch. A user can provide the CPU 34 with instructions for displaying a menu screen, selecting and determining an image, reproducing a slide show, performing an editing operation, and performing post-recording using these switches. When the menu screen is displayed, a slide show single-image display time period T1 or a single-image display period is set to the default value of five seconds on the screen. However, a user can arbitrarily change the slide show single-image display time period T1.

The mode dial 36a and the media selection switch 36b are illustrated in an enlarged manner in FIG. 2B. As illustrated in FIG. 2B, a user can select between a “still” mode, a “movie” mode, a “play” mode and a “power off” mode using the mode dial 36a. The video camcorder 10 performs still image capturing, moving image capturing, image reproduction, or power off processing in accordance with the selection. For example, in a state illustrated in FIG. 2B, the “power off” mode is selected.

The media selection switch 36b is a switch used to select a recording medium to be used from among the memory card 30 and the disc 32. For example, in a state illustrated in FIG. 2B, the memory card 30 is selected. The trigger key 36c is used to instruct the CPU 34 to record an image captured in the still image capturing mode or the moving image capturing mode.

The character generator 38 generates character images to be used on the menu screen that is a setting user interface for various options. On the menu screen, a character-based interface such as CUI (Character-based User Interface) or a graphic-based interface such as GUI (Graphical User Interface) is used. The character generator 38 generates characters and graphics to be displayed on the menu screen.

The data input and output section 40 is compliant with IEEE (Institute of Electrical and Electronic Engineers) 1394 or is a USB (Universal Serial Bus), and can transmit and receive various pieces of data including image data and audio data to or from an external apparatus. Audio data, such as sound data or music data, to be used for post-recording may be obtained via the data input and output section 40.

The speaker 42 selectively receives audio data from the audio input section 16, reproduced audio data, and externally input audio data, and outputs the received audio data as audible sound. As will be described later, the timer 44 is used to measure a time (post-recording processing time) for which audio data is to be added to image data.

Next, the basic operations which the video camcorder 10 performs when capturing an image, recording the image, reproducing the image, and reproducing a slide show in accordance with a reproducing program will be described. For simplification of explanation, description of audio data will be omitted, and only description of image data will be made.

In the still image capturing mode (still) or the moving image capturing mode (movie), the image-capturing section 12 outputs image data corresponding to an optical image of a subject. The camera signal processing section 14 performs well-known camera signal processing upon the image data output from the image-capturing section 12. The image data output from the camera signal processing section 14 is written into the memory 20 via the bus 18. The display control section 22 drives the display section 24 based on the image data stored in the memory 20 to cause the display section 24 to display an image. Consequently, a user can check a subject and a composition on a screen.

In the recording mode, the codec 26 performs compression coding upon the image data stored in the memory 20 and transmits the compressed image data to the I/F 28. The I/F 28 records the compressed image data on the memory card 30 or the disc 32. A user can specify a recording medium used for recording using the media selection switch 36b. Thus, the compressed image data of a captured image is stored on the memory card 30 or the disc 32.

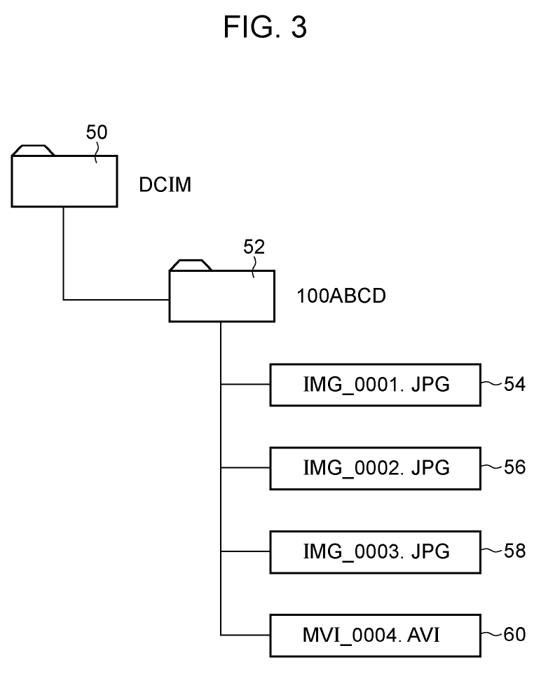

FIG. 3 is a diagram illustrating an exemplary directory configuration in the memory card 30. A directory 50 (directory name: DCIM) is located directly below the root directory. A directory 52 (directory name: 100ABCD) is located directly below the directory 50. A portion “ABCD” of the name of the directory 52 typically corresponds to a camera manufacture's name. A plurality of pieces of still image data 54, 56, and 58 compliant with the JPEG format and moving image data 60 compliant with the AVI format are recorded in the directory 52. Such a directory configuration is compliant with DCF (Design rule for Camera File system). A directory configuration in the disc 32 may be the same as that of the memory card 30.

In the reproduction mode, the I/F 28 reads out compressed image data specified by the memory card 30 or the disc 32 and transmits the read compressed image data to the codec 26. The codec 26 decodes the compressed image data transmitted from the I/F 28 and reproduces the decoded image data. The reproduced image data is supplied to the display section 24 via the display control section 22, whereby a reproduction image is displayed on the screen of the display section 24.

When a user presses a slide show button in the reproduction mode, a slide show is reproduced in accordance with a reproducing program. At that time, the I/F 28 sequentially reads out a plurality of pieces of compressed image data of images specified by the memory card 30 or the disc 32 for a specified single-image display period (the default is five seconds) in the order in which they have been recorded, and transmits the read pieces of compressed image data to the codec 26. The codec 26 decodes the compressed pieces of image data transmitted from the I/F 28 and reproduces the decoded pieces of image data. The reproduced pieces of image data are supplied to the display section 24 via the display control section 22. Consequently, a slide show in which a plurality of reproduction images are consecutively displayed, each of the images being displayed for the single-image display period (five seconds), is displayed on the screen of the display section 24.

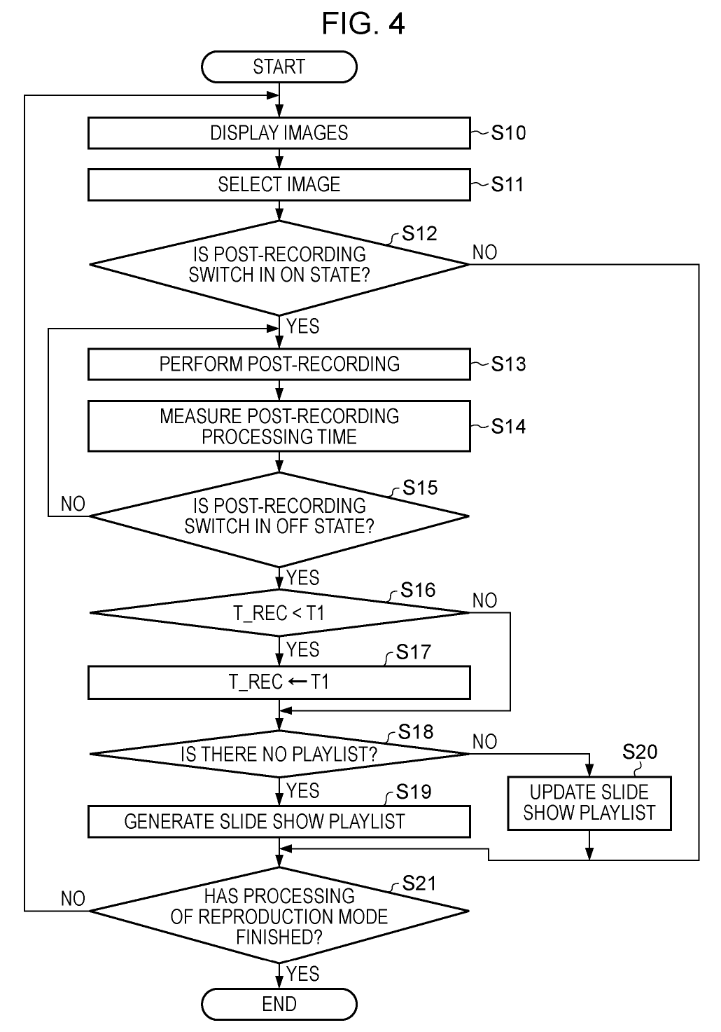

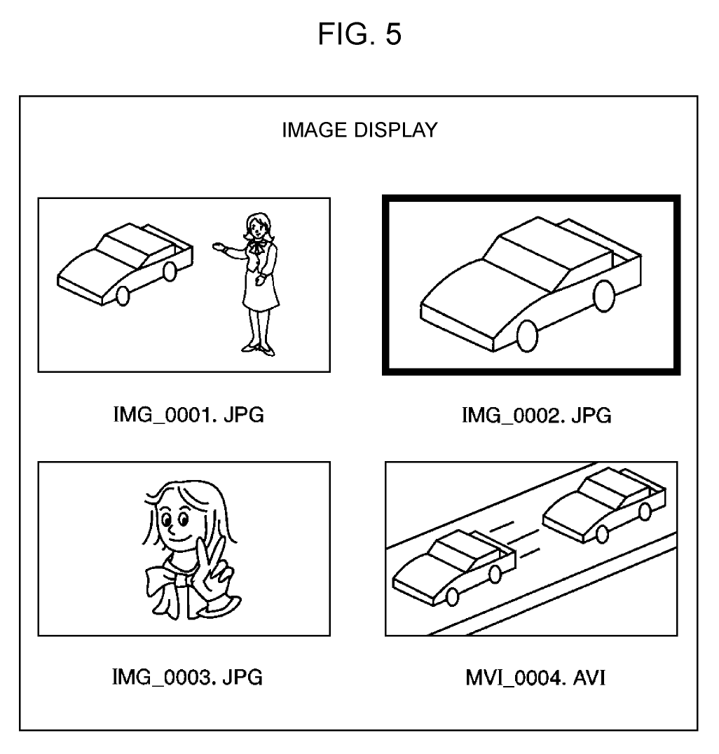

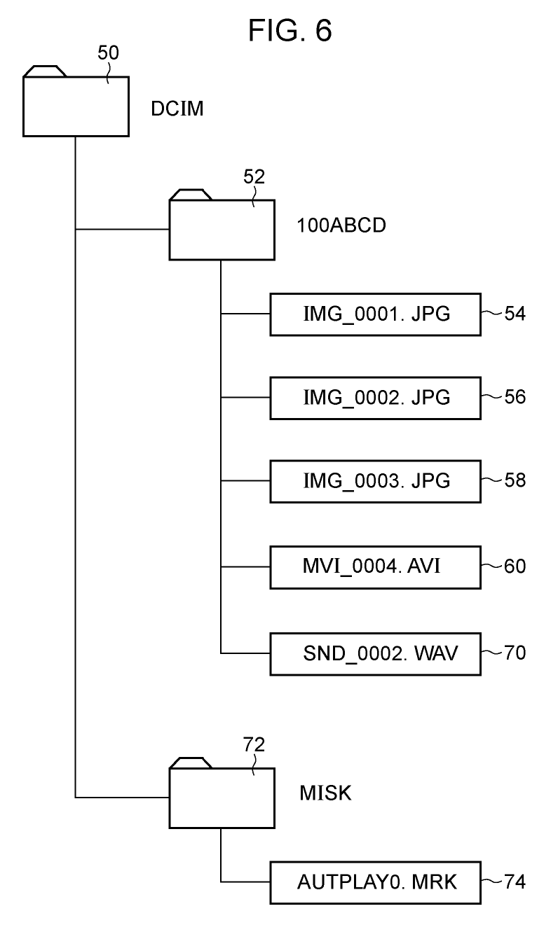

Next, post-recording and reproducing program creation (updating) will be described with reference to FIGS. 4 to 6. FIG. 4 is a flowchart illustrating a procedure for creating a reproducing program according to this embodiment. FIG. 5 is a diagram illustrating exemplary images displayed in rows and columns. FIG. 6 is a diagram illustrating an exemplary directory configuration in a memory card after post-recording has been performed. Here, as illustrated in FIG. 3, it is assumed that the pieces of still image data 54, 56, and 58 and the moving image data 60 are recorded on the memory card 30 and “memory card” is selected using the media selection switch 36b.

First, a user sets the mode dial 36a to “play” so as to set the reproduction mode. In the reproduction mode, as illustrated in FIG. 5, images represented by the image data 54 to 60 recorded on the memory card 30 are displayed in rows and columns (step S10). At that time, representative or thumbnail images of the individual pieces of image data, file names thereof, etc. are displayed. The user selects one of these displayed images using an arrow key and an enter key (step S11). For example, in FIG. 5, an image having a file name of “IMG_{—}0002.JPG” is selected.

The CPU 34 determines whether a post-recording switch is in the ON state when the image is selected (step S12). If the post-recording switch is in the OFF state (No in step S12), the process proceeds to step S21. In this case, a slide show is reproduced in accordance with an existing reproducing program (playlist). If the post-recording switch is in the ON state (Yes in step S12), audio data transmitted from the audio input section 16 or the data input and output section 40 is recorded on the memory card 30 (post-recording is performed) until the post-recording switch is moved to the OFF position (step S13).

In step S13, audio data “SND_{—}0002.WAV” 70 is recorded on the memory card 30 as illustrated in an example in FIG. 6. At that time, the timer 44 and the CPU 34 measure the recording time period of audio data recorded for a period between the ON state and the OFF state of the post-recording switch, that is, a post-recording processing time T_REC (step S14). The post-recording processing time T_REC corresponds to a reproduction period of the audio data when the audio data is reproduced. The audio data recorded as described above is managed along with the image data of the selected image.

If the post-recording switch is still in the ON state (No in step S15), the process returns to step S13 in which the CPU 34 continues to perform the post-recording. On the other hand, if the post-recording switch is moved to the OFF position, the recording of the audio data is stopped (post-recording is stopped) (Yes in step S15), the CPU 34 determines whether the post-recording processing time T_REC is shorter than a slide show single-image display time period T1 that has been set in advance (step S16).

If the post-recording processing time T_REC is shorter than the slide show single-image display time period T1 (Yes in step S16), the CPU 34 replaces the value of the post-recording processing time T_REC with the value of the slide show single-image display time period T1 (step S17). On the other hand, if the post-recording processing time T_REC is longer than the slide show single-image display time period T1 (No in step S16), the process proceeds to step S18. That is, for example, a case in which the post-recording processing time T_REC is ten seconds is considered. In this case, if the slide show single-image display time period T1 is five seconds (default value), the value of the post-recording processing time T_REC is not changed. However, if a user changes the value of the slide show single-image display time period T1 to, for example, fifteen seconds, the value of the post-recording processing time T_REC is changed to fifteen seconds.

Next, the CPU 34 determines whether a playlist to be used by a slide show reproducing program is included in the memory card 30 (step S18). A playlist is recorded in a directory 72 (directory name: MISK) as a file 74 (file name: AUTPLAY0.MRK) as illustrated in FIG. 6. If there is no playlist in the memory card 30 (Yes in step S18), the CPU 34 automatically creates the directory 72 (directory name: MISK). Furthermore, the CPU 34 generates the slide show playlist 74 (file name: AUTPLAY0.MRK), and records it on the memory card 30 (step S19). In the slide show playlist 74, a display period of an image upon which post-recording was not performed is set to the slide show single-image display time period T1, and a display period of an image upon which post-recording was performed is set to the post-recording processing time T_REC. On the other hand, if there is a slide show playlist in the memory card 30 (No in step S18), the CPU 34 updates the playlist by setting a display period of an image upon which post-recording was not performed to the slide show single-image display time period T1 and setting a display period of an image upon which post-recording was performed to the post-recording processing time T_REC (step S20).

The CPU 34 determines whether the processing of the reproduction mode has finished (step S21). If the processing of the reproduction mode has finished (Yes in step S21), the process ends. If the processing of the reproduction mode has not yet finished (No in step S21), the process returns to step S10.

Thus, in the present embodiment, if the post-recording processing time T_REC is shorter than the slide show single-image display time period T1, the value of the post-recording processing time T_REC is replaced by the value of the slide show single-image display time period T1. Accordingly, images in a slide show are not displayed for display periods shorter than the post-recording processing time T_REC. If the post-recording processing time T_REC is longer than the slide show single-image display time period T1, an image is displayed for the post-recording processing time T_REC. Accordingly, even if the post-recording processing time T_REC is longer than the slide show single-image display time period T1, a slide show can be displayed without interrupting sound.

The video camcorder 10 can not only reproduce a slide show of recorded images in accordance with a reproducing program provided therefor in advance but also record a reproducing program, which is edited by performing post-recording, on the memory card 30 (or the disc 32) as a playlist file. In the present embodiment, a created playlist file is recorded on the same recording medium as that recording image data of a plurality of images to be reproduced in the form of a slide show.

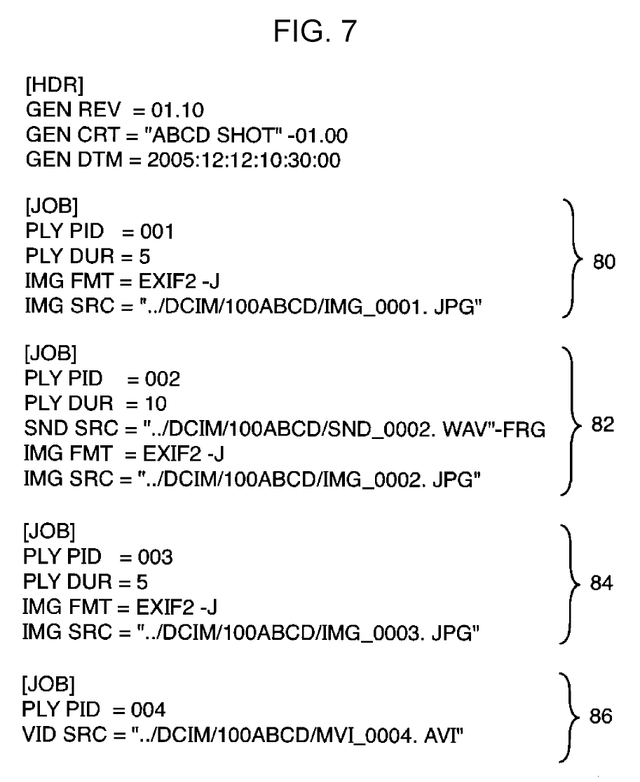

Next, the details of a slide show playlist 74 recorded on the memory card 30 will be described with reference to FIG. 7. The slide show playlist 74 is represented using a description format compliant with DPOF (Digital Print Order Format) Version 1.10. In FIG. 7, the post-recording processing time T_REC is set to ten seconds, and the slide show single-image display time period T1 is set to five seconds.

In FIG. 7, numerals “PLY PID”, “PLY DUR”, “IMG FMT”, “IMG SRC”, and “SND SRC” denote a display sequence, a slide show single-image display period, a recording format, an address representing a storage position of image data, and an address representing a storage position of audio data, respectively.

For example, when a user operates a slide show button, still images (a moving image may be included) and sound are reproduced on the basis of a slide show playlist. In an example illustrated in FIG. 7, image data “IMG_{—}0001.JPG” is displayed for five seconds (step 80). Next, image data “IMG_{—}0002.JPG” is displayed for ten seconds while audio data “SND_{—}0002.WAV” is reproduced (step 82). Next, image data “IMG_{—}0003.JPG” is displayed for five seconds (step 84). Then, moving image data “MVI_{—}0004.AVI” is reproduced (step 86). Thus the reproduction of a slide show is completed.

As is apparent from the description formats, in the present embodiment, a slide show playlist including post-recorded audio data can be automatically generated without requiring a user to perform a special operation.

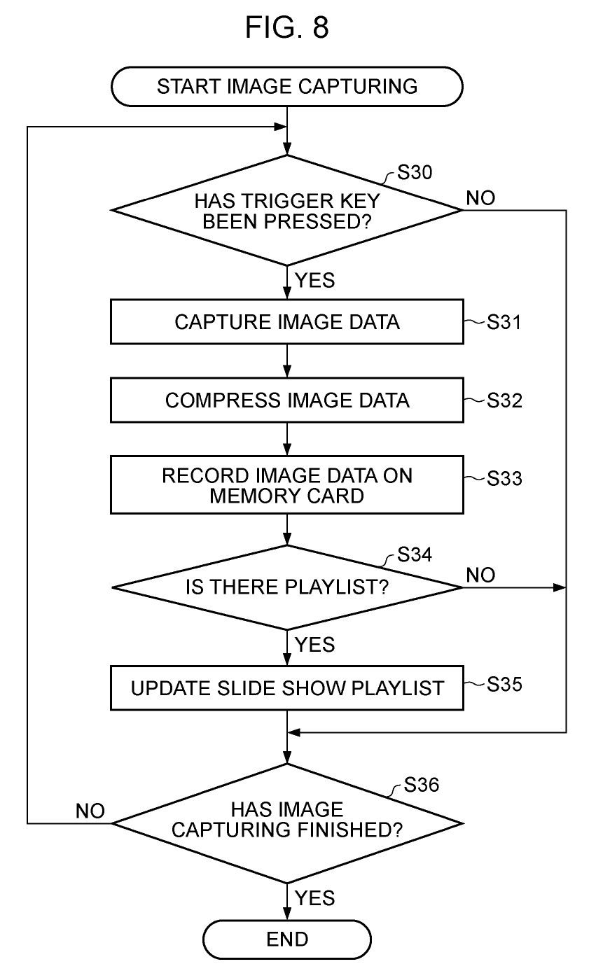

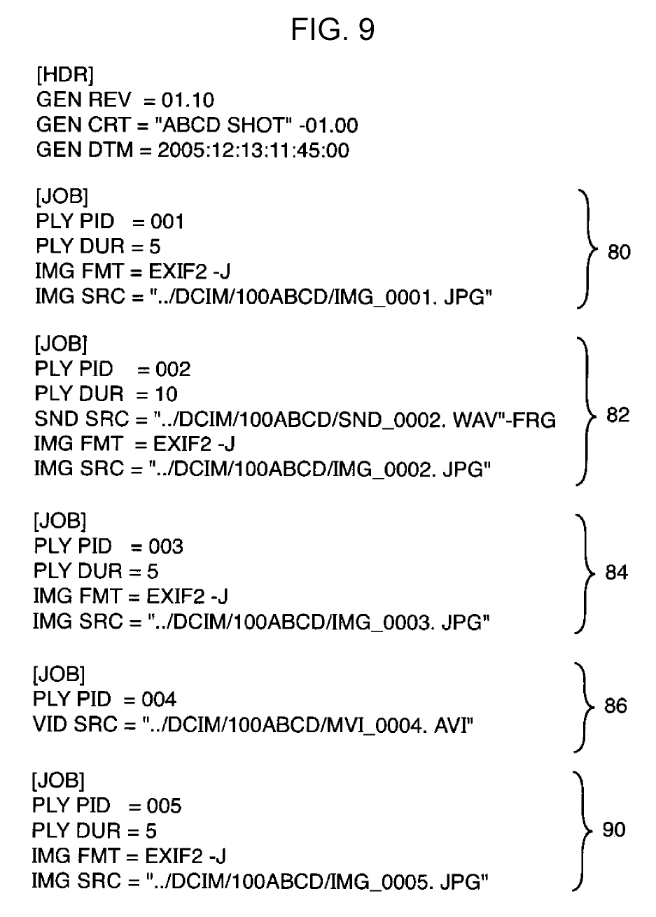

Next, an operational flow at the time of addition of an image will be described with reference to FIGS. 8 and 9. FIG. 8 is a flowchart illustrating the operational flow at the time of addition of an image. FIG. 9 is a diagram illustrating an exemplary description of a slide show playlist after addition of an image has been performed. Here, as illustrated in FIG. 3, it is assumed that the still image data 54, 56, and 58 and the moving image data 60 are recorded on the memory card 30 and “memory card” is selected by the media selection switch 36b.

A user selects the still image capturing mode or the moving image capturing mode by setting the mode dial 36a to “still” or “movie”. After processing of any one of the image capturing modes is started, the CPU 34 determines whether the trigger key 36c has been pressed (step S30). If the trigger key 36c has not been pressed (No in step S30), the process proceeds to step S36. If the trigger key 36c has been pressed (Yes in step S30), data of an image captured by the image-capturing section 12 is stored in the memory 20 via the camera signal processing section 14 and the bus 18 (step S31). The image data stored in the memory 20 is compression-coded by the codec 26 (step S32), and is then recorded on the memory card 30 (step S33).

The CPU 34 determines whether a playlist to be used by a slide show reproducing program is included in the memory card 30 (step S34). If there is a playlist (Yes in step S34), the CPU 34 updates the slide show playlist included in the memory card 30 by adding a newly recorded image to items to be reproduced at the time of reproduction of a slide show (step S35). FIG. 9 illustrates the details of an updated slide show playlist in which an image to be reproduced is added. The addition of the image corresponds to step 90 illustrated in FIG. 9. On the other hand, if there is no slide show playlist (No in step S34), the process proceeds to step S36.

The CPU 34 determines whether an operation for quitting image capturing has been performed (step S36). If the operation for quitting image capturing has not been performed (No in step S36), the process returns to step S30. If the operation for quitting image capturing has been performed (Yes in step S36), the process ends.

Thus, in the present embodiment, the slide show playlist included in the memory card 30 is updated in conjunction with recording of data of a newly captured image by adding description of the image data to the playlist. Accordingly, a user is not required to manually read out a slide show reproducing program and add an image while monitoring the image.

In the present embodiment, description has been made using Auto Play File in DPOF (Digital Print Order Format) Version 1.10 as an example of a slide show playlist. However, any description format, such as SMIL (Synchronized Multimedia Integration Language), XML (extensible Markup Language), SGML (Standard Generalized Markup Language), HTML (Hyper Text Markup Language), and QuickTime® may be used instead of DPOF for the slide show playlist. Furthermore, the case in which a reproducing program (a playlist file) for a slideshow of images recorded on the memory card 30 is created and is then recorded on the memory card 30 has been described. However, a reproducing program for a slide show of images recorded on the disc 32 may be similarly recorded on the disc 32.

A program stored in an RAM or ROM included in a computer is executed, whereby each section configuring the video camcorder 10 according to an embodiment of the present invention can operate and each operational step of the video camcorder 10 can be achieved. This program and the above-described computer readable recording medium recording this program are included in the present invention.

For example, the present invention can be practiced in the forms of a system, an apparatus, a method, a program, a storage medium, etc. More specifically, the present invention may be applied to a system including a plurality of devices or an apparatus formed by a single device.

The present invention may be achieved as follows. A software program achieving the functions of the above-described embodiment (a program corresponding to the flowcharts illustrated in FIGS. 4 and 8) is directly provided for a system or an apparatus. Alternatively, the software program may be remotely provided for the system or the apparatus and the program code is read out and executed by a computer for the system or apparatus, whereby the present invention can be achieved.

Accordingly, the present invention can also be achieved by the program code that is installed on a computer so as to cause the computer to achieve the functional processing of the present invention. That is, a computer program for achieving the functional processing of the present invention is included in the present invention.

Instead of the computer program, other forms such as an object code, a program executed by an interpreter, and script data provided for an OS may be used as long as they have the function of the program. As a recording medium for providing a program, for example, a magnetic disk, a hard disk, an optical disc, a magneto-optical disk, a CD-ROM, a CD-R, a CD-RW, a magnetic tape, a nonvolatile memory card, a ROM, and a DVD (DVD-ROM or DVD-R) may be used.

A program may be provided by connecting a client computer to an Internet home page via the browser of the client computer, and downloading a computer program according to an embodiment of the present invention from the home page. Alternatively, a compressed file that has an automatic installation function may be downloaded to a recording medium such as a hard disk.

In addition, a program according to an embodiment of the present invention may be provided in such a manner that a program code configuring the program is divided into a plurality of files, and the divided files are individually downloaded from different home pages. That is, a WWW server that allows a plurality of users to download program files required for causing a computer to perform functional processing of the present invention is included in the present invention.

A program according to an embodiment of the present invention may be encrypted, be stored on a storage medium such as a CD-ROM, and then be provided to a user. If the user satisfies predetermined conditions, the user is allowed to download decryption key information from a home page via the Internet. The user executes the encrypted program using the downloaded decryption key information, and then installs the program on a computer. When the computer executes the program, the functions of the above-described embodiment can be achieved.

Furthermore, an OS or the like running on the computer may perform a part of or all of the processing in accordance with the instruction of the program, whereby the functions of the above-described embodiment can be achieved. Still furthermore, the program read out from the recording medium may be written in a function expansion board inserted into a computer or in a memory provided for a function expansion unit connected to a computer. Subsequently, a CPU provided for the function expansion board or the function expansion unit performs a part of or all of the processing in accordance with the instruction of the program, whereby the functions of the above-described embodiment can be achieved.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures and functions.

This application claims the benefit of Japanese Application No. 2006-145622 filed May 25, 2006, which is hereby incorporated by reference herein in its entirety.

What is claimed is:

1. An image reproducing apparatus configured to reproduce a plurality of pieces of image data in accordance with a reproducing program for specifying display periods of the plurality of pieces of image data to be reproduced and a display sequence thereof, the image reproducing apparatus comprising:
a selection unit configured to select one of a plurality of pieces of image data recorded on a recording medium;
a recording unit configured to perform post-recording of audio data upon a piece of image data selected by the selection unit;
a measurement unit configured to measure a recording time period of the audio data post-recorded by the recording unit; and
a control unit configured to create or update the reproducing program based on the audio data recording time period measured by the measurement unit.

2. The image reproducing apparatus according to claim 1, wherein the control unit creates or updates information on a display period of the piece of image data selected by the selection unit based on the audio data recording time period measured by the measurement unit, wherein the information on a display period of the selected piece of image data is described by the reproducing program.

3. The image reproducing apparatus according to claim 2,
wherein the control unit compares a display time period of the piece of image data selected by the selection unit which has been determined in advance with the audio data recording time period measured by the measurement unit, and
wherein, when the audio data recording time period measured by the measurement unit is longer than the display time period, the control unit updates the reproducing program by changing the information on a display period of the piece of image data selected by the selection unit based on the measured audio data recording time period.

4. The image reproducing apparatus according to claim 1,
wherein the control unit determines whether an information file corresponding to the reproducing program is recorded on the recording medium, and
wherein the control unit updates the information file when the information file is recorded on the recording medium, and creates a new information file and records the new information file on the recording medium when the information file is not recorded on the recording medium.

5. The image reproducing apparatus according to claim 4, wherein the control unit updates the information file recorded in a predetermined directory on a removable recording medium that records the plurality of pieces of image data.

6. The image reproducing apparatus according to claim 4, wherein the control unit records the created information file in a predetermined directory on a removable recording medium that records the plurality of pieces of image data.

7. The image reproducing apparatus according to claim 1,
wherein the recording unit can record new image data on the recording medium, and
wherein the control unit updates the reproducing program in conjunction with recording of the new image data by adding a description of the new image data to the reproducing program.

8. The image reproducing apparatus according to claim 1, wherein the reproducing program is a program used to reproduce a slide show of the plurality of pieces of image data recorded on the recording medium.

9. The image reproducing apparatus according to claim 1, wherein the reproducing program is recorded on the recording medium as a playlist file.

10. The image reproducing apparatus according to claim 9, wherein the playlist file is recorded in a predetermined directory on a removable recording medium that records the plurality of pieces of image data.

11. A reproducing program creation apparatus configured to create a reproducing program for specifying display periods of a plurality of pieces of image data to be reproduced and a display sequence thereof, the reproducing program creation apparatus comprising:
a selection unit configured to select one of a plurality of pieces of image data recorded on a recording medium;
a recording unit configured to perform post-recording of audio data upon a piece of image data selected by the selection unit;
a measurement unit configured to measure a recording time period of the audio data post-recorded by the recording unit; and
a program creation unit configured to create a new reproducing program based on the audio data recording time period measured by the measurement unit.

12. A reproducing program creation apparatus configured to create a reproducing program for specifying display periods of a plurality of pieces of image data to be reproduced and a display sequence thereof, the reproducing program creation apparatus comprising:
a selection unit configured to select one of a plurality of pieces of image data recorded on a recording medium;
a recording unit configured to perform post-recording of audio data upon a piece of image data selected by the selection unit;
a measurement unit configured to measure a recording time period of the audio data post-recorded by the recording unit; and
a program updating unit configured to update an existing reproducing program based on the audio data recording time period measured by the measurement unit.

13. A method of reproducing a plurality of pieces of image data in accordance with a reproducing program for specifying display periods of the plurality of pieces of image data to be reproduced and a display sequence thereof, the method comprising:
selecting one of a plurality of pieces of image data recorded on a recording medium;
performing post-recording of audio data upon a selected piece of image data;
measuring a recording time period of the audio data; and
creating or updating the reproducing program based on the measured audio data recording time period.

14. A computer-readable storage medium storing computer-executable process steps, the computer-executable process steps causing a computer to execute the method of claim 13.

15. A method of creating a reproducing program for specifying display periods of a plurality of pieces of image data to be reproduced and a display sequence thereof, the method comprising:
selecting one of a plurality of pieces of image data recorded on a recording medium;
performing post-recording of audio data upon a selected piece of image data;
measuring a recording time period of the audio data; and
creating a new reproducing program based on the measured audio data recording time period.

16. A computer-readable storage medium storing computer-executable process steps, the computer-executable process steps causing a computer to execute the method of claim 15.

17. A method of creating a reproducing program for specifying display periods of a plurality of pieces of image data to be reproduced and a display sequence thereof, the method comprising:
selecting one of a plurality of pieces of image data recorded on a recording medium;
performing post-recording of audio data upon a selected piece of image data;
measuring a recording time period of the audio data; and
updating an existing reproducing program based on the measured audio data recording time period.

18. A computer-readable storage medium storing computer-executable process steps, the computer-executable process steps causing a computer to execute the method of claim 17.
